(19) United States
(12) Patent Application Publication
(10) Pub. No.: US 2011/0143192 A1
(43) Pub. Date: Jun. 16, 2011

(54) NEGATIVE ELECTRODE ACTIVE MATERIAL FOR LITHIUM ION SECONDARY BATTERY AND LITHIUM ION SECONDARY BATTERY USING THE SAME

(76) Inventors: Kensuke Nakura, Osaka (JP); Yasunari Sugita, Osaka (JP)

(21) Appl. No.: 13/058,269

(22) PCT Filed: May 27, 2010
(86) PCT No.: PCT/JP2010/003571

§ 371 Date: Feb. 9, 2011

(30) Foreign Application Priority Data
Jun. 15, 2009 (JP) 2009-141983

(51) Int. Cl. H01M 2/02; H01M 4/485

(52) U.S. Cl. 429/163; 252/182.1

(57) ABSTRACT

A negative electrode active material which is low-cost, and has a high energy density, and a lithium ion secondary battery using such a negative electrode active material are provided. The lithium ion secondary battery which is low-cost, and has both a high energy density and high reliability can be obtained by using a negative electrode active material made of metal composite oxide represented by the formula A_{2±x}B_{2±y}O_{5±z}; (1) (0≦x≦0.1, 0≦y≦0.1, 0≦z≦0.3, A includes one selected from the group consisting of strontium, barium, and magnesium, but does not include manganese and calcium, and B includes at least Fe, but does not include manganese), where the formal oxidation number of A is +2, and the formal oxidation number of B is greater than or equal to +2.5 and less than or equal to +3.3.

### TECHNICAL FIELD

The present invention relates to negative electrode active materials for lithium ion secondary batteries and lithium ion secondary batteries using the same.

### BACKGROUND ART

In recent years, production of portable and cordless electronic devices has rapidly been increasing. Thus, as power supplies for driving such devices, demands for small, lightweight secondary batteries having a high energy density have also been increasing. Moreover, development of technology for large secondary batteries used for electric power storages of small consumer applications and for electric vehicles which require long-term durability and safety has been accelerated.

From this perspective, nonaqueous electrolyte secondary batteries, particularly lithium ion secondary batteries have a high voltage and a high energy density, and thus have been expected to serve as power supplies for electronic devices, electric power storages, or power supplies for electric vehicles.

Such a lithium ion secondary battery includes a positive electrode, a negative electrode, and a separator provided between the positive electrode and the negative electrode, wherein the separator is a microporous film made of mainly polyolefin. As a nonaqueous electrolyte, liquid lithium (nonaqueous electrolyte) obtained by dissolving a lithium salt such as LiBF₄ or LiPF₆ in an aprotic organic solvent is used. Moreover, lithium ion secondary batteries in which lithium cobalt oxide (e.g., LiCoO₂) having a high potential with respect to lithium and high safety, and being relatively easily synthesized is used as a positive electrode active material, and various carbon materials such as graphite, etc. are used as a negative electrode active material are in practical use.

It is known that in a conventional lithium ion secondary battery using a carbon material as a negative electrode active material, the oxidation-reduction potential of the carbon material is close to a potential at which a lithium metal is deposited, and thus charge at a high rate, slightly uneven charge in the electrodes, or the like easily leads to the deposition of the lithium metal on a surface of the negative electrode, thereby causing life degradation (particularly, at a low temperature) and lowering the degree of safety.

Such deposition of lithium metal is a particularly serious problem for developing large lithium ion secondary batteries in an environmental energy field including electric power storages and electric vehicles which require long-term durability and a higher safety.

Then, a negative electrode active material which is oxidized and reduced at a high potential that is not close to the potential at which the lithium metal is deposited has been proposed.

Examples of the negative electrode active material include Li₄Ti₅O₁₂ having an operating potential of 1.5 V with respect to a Li counter electrode (see PATENT DOCUMENT 1), and a perovskite-type oxide negative electrode reported to operate in the 0 V-1 V range (see PATENT DOCUMENT 2).

### CITATION LIST

### Patent Document

PATENT DOCUMENT 1: Japanese Patent Publication No. H06-275263

PATENT DOCUMENT 2: Japanese Patent Publication No. H06-275269

### SUMMARY OF THE INVENTION

### Technical Problem

However, since Li₄Ti₅O₁₂ of PATENT DOCUMENT 1 has an excessively high operating potential of 1.5 V with respect to a lithium metal, the lithium ion secondary battery loses its advantage of having a high energy density.

Moreover, considering use in environmental energy applications, elements of the perovskite-type oxide negative electrode in PATENT DOCUMENT 2 are limited to manganese, iron, and alkaline earth in terms of low cost and resource reserves. In this case, since the formal oxidation numbers of manganese and iron which can be the redox center are 3.4-4, an operating voltage with respect to the lithium metal is about 1 V, so that it is not possible to obtain a sufficiently high energy density.

Thus, an object of the present invention is to provide a negative electrode active material which can be produced at a low cost and has a high energy density, and a lithium ion secondary battery using such a negative electrode active material.

### Solution to the Problem

To solve the problems discussed above, a negative electrode active material for a lithium ion secondary battery of the present invention is made of a metal composite oxide represented by a formula A_{2±x}B_{2±y}O_{5±z}; (1) (0≦x≦0.1, 0≦y≦0.1, 0≦z≦0.3, A includes one selected from the group consisting of strontium, barium, and magnesium, but does not include manganese and calcium, and B includes at least iron, but does not include manganese), wherein a formal oxidation number of A is +2, and a formal oxidation number of B is greater than or equal to +2.5 and less than or equal to +3.3.

Here, the formal oxidation number is a valence obtained on the presupposition that the electrical neutrality condition is satisfied in formula (1) provided that when A is an alkaline earth metal, the oxidation number of oxygen is −2, and the oxidation number of the alkaline earth metal is +2. Provided that the oxidation number of oxygen is −2 when A is a transition metal, the formal oxidation number is a valence deduced from a result of analyzing a stoichiometric composition A₂B₂O₅ by XENES.

A lithium ion secondary battery of the present invention includes: a negative electrode plate; a positive electrode plate; a separator provided between the negative electrode plate and the positive electrode plate; a nonaqueous electrolyte; and a battery case, wherein the nonaqueous electrolyte and an electrode plate group including the negative electrode plate, the positive electrode plate, and the separator are sealed in the battery case, and the negative electrode plate includes the negative electrode active material described above.

### ADVANTAGES OF THE INVENTION

According to the present invention, it is possible to provide a negative electrode active material, and a lithium ion secondary battery which are low-cost, and have both a high energy density and high reliability.

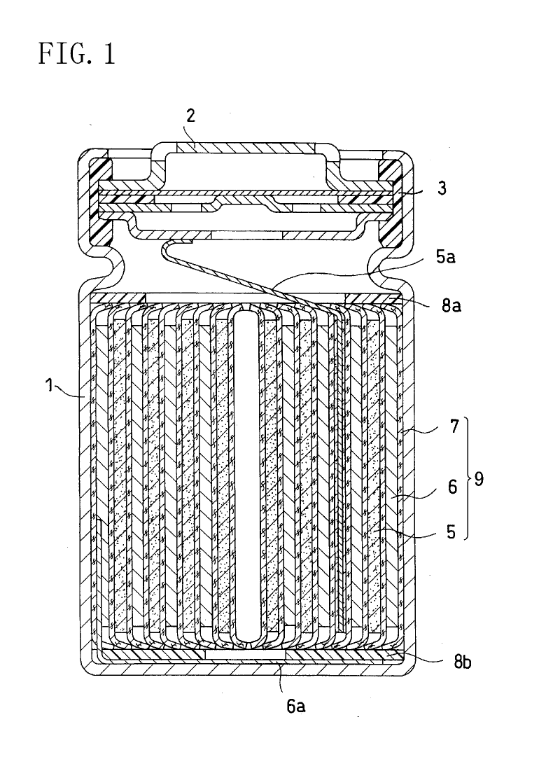

### BRIEF DESCRIPTION OF THE DRAWINGS

[FIG. 1] FIG. 1 is a longitudinal section of a cylindrical lithium ion secondary battery according to an embodiment.

### DESCRIPTION OF EMBODIMENTS

The inventors of the present application carried out various experiments to obtain a negative electrode active material satisfying all the conditions of being low-cost, and having a high energy density and high reliability. As a result, the inventors determined that a composite metal oxide in which the formal oxidation number of low-cost iron capable of being the redox center is close to 3, and which has sites allowing intercalation of lithium ions is an examination object as a promising material. The inventors examined various compositions and structures of this composite oxide, which resulted in the present invention.

Embodiments of the present invention will be described below.

### First Embodiment

A lithium ion secondary battery of a first embodiment has a feature in a negative electrode active material, and other components thereof are not particularly limited. Thus, the negative electrode active material will first be described.

The present embodiment uses, as the negative electrode active material, a metal composite oxide represented by the formula A_{2±x}B_{2±y}O_{5±z}; (1) (0≦x≦0.1, 0≦y≦0.1, 0≦z≦0.3, A includes one selected from the group consisting of strontium, barium, and magnesium, but does not include manganese and calcium, and B includes at least iron, but does not include manganese), where the formal oxidation number of A is +2, and the formal oxidation number of B is greater than or equal to +2.5 and less than or equal to +3.3. In this way, it is possible to obtain a lithium ion secondary battery which is low-cost, and has both a high energy density that the oxidation-reduction potential of a negative monopole is around 0.5 V-0.7 V with respect to a lithium metal, and high reliability. Each of A and B may include one kind of element, or may include two or more kinds of elements. Note that as a part of the above metal composite oxide, negative electrode active materials other than those mentioned above may be used.

If the element A is Sr, a crystal structure of formula (1) A_{2±x}B_{2±y}O_{5±z} of the present embodiment belongs to the space group Icmm, the element A and oxygen are on the 8h site, the element B and oxygen are on the 8i site, oxygen is on the 8 g site, and the element B is on the 4a site. Moreover, if the element A is Ba, the crystal structure belongs to the space group P 1 21/c 1, the element A, the element B and oxygen are on the 4e site, and oxygen is on the 2a site.

Moreover, if the element A is Mg, the crystal structure belongs to the space group Pcmn, the element A and oxygen are on the 8d site, the element B is on the 4a site, and the element B and oxygen are on the 4c site.

In the crystal structure of formula (1) A_{2±x}B_{2±y}O_{5±z} described above, an octahedron in which the element B having six oxygen atoms at vertices is present at a center position shares an edge with an oxygen-deficient octahedron which is an octahedron having the same structure as that of the above octahedron except that one oxygen atom is deficient.

Moreover, the crystal represented by A_{2±x}B_{2±y}O_{5±z} of the present embodiment includes iron in a state in which the iron has a relatively small valence between 2.5 and 3.3, both inclusive, and the oxidation-reduction potential of the iron is phenomenologically about 0.5 V-0.7 V with respect to the lithium metal. Moreover, due to the presence of an oxygen-deficient site, lithium ions easily move in the crystal, so that a higher capacity is obtained in comparison to a perovskite-type oxide negative electrode.

In the crystal structure represented by A_{2±x}B_{2±y}O_{5±z} of the present embodiment, the energy level of the 5s orbit of Sr, the 6s orbit of Ba, or the 3s orbit of Mg, respectively which serves as the element A is higher than that of the 3d orbit or the 4d orbit of the element B. Since the energy level of the 4p orbit of Sr, the 5p orbit of Ba, or the 2p orbit of Mg is lower than that of the 3d orbit or the 4d orbit of the element B, the formal oxidation number of the Sr, Ba, Mg is +2. Moreover, since the formal oxidation number of oxygen is −2, the formal oxidation number of the element B is +2.5 to +3.3 in the composition range of formula (1) provided that the electrical neutrality condition is satisfied. Here, the element B is preferably a transition metal.

A_{2±x}B_{2±y}O_{5±z} of the present embodiment can obtain a single phase only in a range in which x and y are both greater than or equal to 0 and less than or equal to 0.1, and z is greater than or equal to 0 and less than or equal to 0.3. Moreover, in particular, the composition A₂B₂O₅ is most stable and easily synthesized, and this is preferable.

To produce the composite oxide represented by formula (1) of the present embodiment, iron metal, FeO, Fe₂O₃, Fe₃O₄, Fe₅O₈, FeOOH, FeCO₃, FeNO₃, Fe(COO)₂, Fe(CHCOO)₂, or the like is preferably used as an iron starting material. As FeOOH, FeOOH having an α-type, β-type, or γ-type crystal structure can be used. Moreover, one of these iron starting materials may be used solely, or two or more of them may be used in combination. Here, iron present in A_{2±x}B_{2±y}O_{5±z} is in a state in which the valence of the iron is +2.5 to +3.3 (Fe^{2.5+} to Fe^{3.3+}), and thus it is preferable to use iron having a valence of +2.5 to +3.3 (Fe^{2.5+} to Fe^{3.3+}) in its starting material stage. Particularly preferable iron starting materials are FeO, Fe₂O₃, Fe₃O₄, Fe₅O₈, FeOOH, FeCO₃, and Fe(CHCOO)₂.

On the other hand, as a strontium starting material, strontium oxide, strontium chloride, strontium bromide, strontium sulfate, strontium hydroxide, strontium nitrate, strontium carbonate, strontium formate, strontium acetate, strontium citrate, or strontium oxalate is preferably used.

Moreover, as a barium starting material, barium oxide, barium peroxide, barium chlorate, barium chloride, barium bromide, barium sulfite, barium sulfate, barium hydroxide, barium nitrate, barium carbonate, barium acetate, barium citrate, or barium oxalate is preferably used.

Furthermore, as a magnesium starting material, magnesium oxide, magnesium chloride, magnesium sulfate, magnesium hydroxide, magnesium nitrate, magnesium carbonate, magnesium formate, magnesium acetate, magnesium benzoate, magnesium citrate, or magnesium oxalate is preferably used.

One of the above starting materials may be used solely, or two or more of them may be used in combination.

As for the mixing ratio of the starting materials, the starting materials are preferably mixed so that the atom ratio of the element A to the element B is 1:1. Moreover, synthesis is possible even when the atom ratio of the element A to the element B is other than 1:1, for example, even in the case of a mixture of the element A to the element B at an atom ratio of 1.9:2.1 to 2.1:1.9.

A_{2±x}B_{2±y}O_{5±z} is preferably obtained by, for example, pulverizing the above starting materials and mixing the obtained materials together, and burning the obtained mixture at 300° C.-2000° C. in a reducing atmosphere (which is preferably a nitrogen atmosphere or an argon atmosphere, and whose oxygen partial pressure converted to a volume fraction is preferably 1% or lower), or in an air atmosphere. Note that a temperature that is too low may lead to a low degree of reactivity, which may require long-term burning to obtain a single phase, but an excessively high temperature, in contrast, may increase production cost. Thus, an especially preferable burning temperature is 600° C.-1500° C.

The above synthesizing method is not intended to be limitative, and other various synthesizing methods such as a hydrothermal synthesis method and a coprecipitation method can be used.

Next, a negative electrode using the above negative electrode active material will be described.

The negative electrode generally includes a negative electrode current collector, and a negative electrode mixture provided on the negative electrode current collector. The negative electrode mixture can contain a binder, a conductive agent, and the like in addition to the negative electrode active material. The negative electrode is formed by, for example, mixing the negative electrode mixture containing the negative electrode active material and arbitrary components with a liquid component to prepare a negative electrode mixture slurry, applying the obtained slurry to the negative electrode current collector, and then drying the applied slurry.

The component ratio of the negative electrode active material to the negative electrode is preferably greater than or equal to 93% by mass and less than or equal to 99% by mass. The component ratio of the binder to the negative electrode is preferably greater than or equal to 1% by mass and less than or equal to 10% by mass.

As the current collector, a conductor substrate having an elongated porous structure or a nonporous conductor substrate is used. As the negative electrode current collector, for example, stainless steel, nickel, or copper is used. The thickness of the negative electrode current collector is not particularly limited, but is preferably 1 μm-500 μm, and is more preferably 5 μm-20 μm. The thickness of the negative electrode current collector is set in the range mentioned above, so that the weight of an electrode plate can be reduced while maintaining its strength.

In the same manner as the negative electrode, a positive electrode is formed by mixing a positive electrode mixture containing a positive electrode active material and arbitrary components with a liquid component to prepare a positive electrode mixture slurry, applying the obtained slurry to a positive electrode current collector, and then drying the applied slurry.

Examples of the positive electrode active material of the lithium ion secondary battery of the present embodiment include: composite oxide such as lithium cobaltate and denatured lithium cobaltate (e.g., a eutectic with aluminum or magnesium), lithium nickelate and denatured lithium nickelate (e.g., nickel partially substituted with cobalt or manganese), and lithium manganate and denatured lithium manganate; and phosphate such as lithium iron phosphate and denatured lithium iron phosphate, and lithium manganese phosphate and denatured lithium manganese phosphate.

One of the positive electrode active materials may be used solely, or two or more of them may be used in combination.

The binder of the positive electrode or the negative electrode can be, for example, PVDF, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyethersulfone, hexafluoropolypropylene, styrene-butadiene-rubber, carboxymethylcellulose, etc. Moreover, a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene may be used. Moreover, two or more materials selected from the above materials may be used in combination. Moreover, examples of the conductive agent contained in the electrode include graphites such as natural graphite and artificial graphite, carbon blacks such as acetylene black, ketjen black, channel black, furnace black, lamp black, and thermal black, conductive fibers such as carbon fiber and metal fiber, powders of metal such as fluorocarbon and aluminum, conductive whiskers such as zinc oxide and potassium titanate, conductive metal oxide such as titanium oxide, and organic conductive materials such as phenylene derivative.

The component ratio of the positive electrode active material to the positive electrode is preferably in a range from 80% by mass to 97% by mass, both inclusive. The component ratio of the conductive agent to the positive electrode is in a range from 1% by mass to 20% by mass, both inclusive. The component ratio of the binder to the positive electrode is in a range from 1% by mass to 10% by mass, both inclusive.

The positive electrode current collector may be, for example, stainless steel, aluminum, or titanium. The thickness of the positive electrode current collector is not particularly limited, but is preferably 1 μm-500 μm, and is more preferably 5 μm-20 μm. The thickness of the positive electrode current collector is set in the above range, so that the weight of the electrode plate is reduced while maintaining its strength.

Examples of a separator provided between the positive electrode and the negative electrode include a microporous thin film, woven fabric, and nonwoven fabric which have high ion permeability, and have both a predetermined mechanical strength and insulation properties. As a material of the separator, for example, polyolefin such as polypropylene and polyethylene is preferable in view of safety of lithium ion secondary batteries because polyolefin has high durability and a shut-down function. The thickness of the separator is generally 10 μm-300 μm, but is preferably 40 μm or smaller. The thickness of the separator is more preferably in a range from 15 μm to 30 μm. The thickness of the separator is much more preferably in a range from 10 μm to 25 μm. Further, the microporous film may be a single-layer film made of one kind of material, or may be a composite film or a multilayer film made of one kind of material, or two or more kinds of materials. Furthermore, the porosity of the separator is preferably in a range from 30% to 70%. Here, the porosity means the volume ratio of pores with respect to the volume of the separator. The porosity of the separator is more preferably in a range from 35% to 60%.

As an electrolyte, a liquid, a gelled, or a solid (solid polymer electrolyte) material can be used.

The liquid nonaqueous electrolyte (nonaqueous electrolyte) can be obtained by dissolving electrolyte (e.g., lithium salt) in a nonaqueous solvent. Moreover, the gelled nonaqueous electrolyte contains a nonaqueous electrolyte and a polymer material for holding the nonaqueous electrolyte. As the polymer material, for example, polyvinylidene fluoride, polyacrylonitrile, polyethylene oxide, polyvinyl chloride, polyacrylate, or polyvinylidene fluoride hexafluoropropylene is preferably used.

As the nonaqueous solvent in which the electrolyte is dissolved, a known nonaqueous solvent can be used. The kind of the nonaqueous solvent is not particularly limited, but for example, cyclic carbonic ester, chain carbonic ester, cyclic carboxylate, etc. can be used. Examples of cyclic carbonic ester include propylene carbonate (PC) and ethylene carbonate (EC). Examples of chain carbonic ester include diethyl carbonate (DEC), ethyl methyl carbonate (EMC), and dimethyl carbonate (DMC). Examples of cyclic carboxylate include γ-butyrolactone (GBL), and γ-valerolactone (GVL). One of the nonaqueous solvents may be used solely, or two or more of them may be used in combination.

Examples of the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, and imidates. Examples of the borates include bis(1,2-benzene diolate(2-)-O,O′)lithium borate, bis(2,3 -naphthalene diolate(2-)-O,O′)lithium borate, bis(2,2′-biphenyl diolate(2-)-O,O′) lithium borate, and bis(5-fluoro-2-olate-1-benzenesulfonic acid-O,O′)lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)), and lithium bispentafluoroethanesulfonimide ((C₂F₅SO₂)₂NLi). One of these electrolytes may be used solely, or two or more of them may be used in combination.

Moreover, the nonaqueous electrolyte may contain, as an additive, a material which is decomposed on the negative electrode and forms thereon a coating having high lithium ion conductivity to enhance the charge-discharge efficiency. Examples of the additive having such a function include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. One of the additives may be used solely, or two or more of them may be used in combination. Among the additives, at least one selected from the group consisting of vinylene carbonate, vinyl ethylene carbonate, and divinyl ethylene carbonate is preferable. Note that in the above compounds, hydrogen atoms may be partially substituted with fluorine atoms. The amount of the electrolyte dissolved in the nonaqueous solvent is preferably in the range from 0.5 mol/L to 2 mol/L.

The nonaqueous electrolyte may further contain a known benzene derivative which is decomposed during overcharge and forms a coating on the electrode to inactivate the battery. The benzene derivative preferably includes a phenyl group and a cyclic compound group adjacent to the phenyl group. Examples of the cyclic compound group preferably include a phenyl group, a cyclic ether group, a cyclic ester group, a cycloalkyl group, and a phenoxy group. Examples of the benzene derivative include cyclohexylbenzene, biphenyl, and diphenyl ether. One of these derivatives may be used solely, or two or more of them may be used in combination. Note that the content of the benzene derivative is preferably 10 vol % or less of the total volume of the nonaqueous solvent.

Next, the present embodiment will be described based on examples.

In FIG. 1, a longitudinal section of a cylindrical battery fabricated in present examples is shown.

A lithium ion secondary battery of FIG. 1 includes a battery case 1 made of stainless steel, and an electrode plate group 9 placed in the battery case 1. The electrode plate group 9 includes a positive electrode 5, a negative electrode 6, and a separator 7 made of polyethylene. The positive electrode 5 and the negative electrode 6 are wound in a spiral with the separator 7 interposed therebetween. An upper insulating plate 8a and a lower insulating plate 8b are provided over and under the electrode group 9, respectively. A sealing plate 2 is crimped to an opening end of the battery case 1 with a gasket 3 interposed therebetween to seal the opening end. One end of a positive electrode lead 5a made of aluminum is attached to the positive electrode 5, and the other end of the positive electrode lead 5a is connected to the sealing plate 2 also serving as a positive electrode terminal. One end of a negative electrode lead 6a made of nickel is attached to the negative electrode 6, and the other end of the negative electrode lead 6a is connected to the battery case 1 also serving as a negative electrode terminal.

### FIRST EXAMPLE

(1) Production of Negative Electrode Active Material

Using a mortar made of agate, 240 g of Fe₂O₃ and 443 g of SrCO₃ were mixed together well. Then, after reaction of the obtained mixture in an air atmosphere at 1200° C. for 12 hours, the mixture was annealed in a nitrogen atmosphere at 950° C., thereby obtaining a negative electrode active material R1 made of strontium iron composite oxide Sr₂Fe₂O₅. An ICP analysis confirmed that the negative electrode active material R1 has a stoichiometric composition in which the substantial composition is Sr₂Fe₂O₅.

In a crystal structure of Sr₂Fe₂O₅, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +3.

(2) Formation of Negative Electrode Plate

Four parts by weight of graphite as a conductive agent and a solution in which 5 parts by weight of polyvinylidene fluoride (PVDF) as a binder is dissolved in N-methyl pyrrolidone (NMP) serving as a solvent were added to 100 parts by weight of the negative electrode active material R1, and these materials were mixed, thereby obtaining paste containing a negative electrode mixture. The paste was applied to both surfaces of copper foil which will serve as a current collector and has a thickness of 10 μm, and the applied paste was dried. Then, the copper foil provided with the paste was rolled, and cut to have a predetermined dimension, thereby obtaining a negative electrode plate.

(3) Production of Positive Electrode Active Material

A positive electrode active material is formed as follows. Nickel manganese cobalt oxyhydroxide (NiMnCoOOH; Ni:Mn:Co=1:1:1) and lithium hydroxide (LiOH) were mixed together well to obtain a preferable composition. The obtained mixture was pressed to form a pellet. The obtained pellet was burned in air at 650° C. for 10-12 hours (preliminary burning). The pellet after the preliminary burning was pulverized. The pulverized product was burned in air at 1000° C. for 10-12 hours (secondary burning). A positive electrode active material made of a lithium nickel manganese composite oxide was thus synthesized.

(4) Formation of Positive Electrode Plate

Five parts by weight of acetylene black serving as a conductive agent and 5 parts by weight of polyvinylidene fluoride resin serving as a binder were added to 100 parts by weight of powders of lithium nickel manganese composite oxide, and these materials were mixed. These materials were dispersed in dehydrated N-methyl-2-pyrrolidone, thereby preparing a slurry positive electrode mixture. The positive electrode mixture was applied to both surfaces of a positive electrode current collector made of aluminum foil, and the applied mixture was dried. Then, the aluminum foil provided with the mixture was rolled and cut to have a predetermined dimension, thereby obtaining a positive electrode plate.

(5) Preparation of Nonaqueous Electrolyte

To a mixture solvent of ethylene carbonate and ethyl methyl carbonate in a volume ratio of 1:3, 1 weight percent (wt. %) of vinylene carbonate was added, and LiPF₆ was dissolved in a concentration of 1.0 mol/L, thereby obtaining a nonaqueous electrolyte.

(6) Fabrication of Cylindrical Battery

First, a positive electrode lead 5a made of aluminum and a negative electrode lead 6a made of nickel were attached to the current collectors of the positive electrode 5 and the negative electrode 6, respectively. Then, the positive electrode 5 and the negative electrode 6 were wound with a separator 7 provided therebetween, thereby forming an electrode plate group 9. Insulating plates 8a and 8b were provided over and under the electrode plate group 9, respectively. The negative electrode lead 6a was welded to a battery case 1, and the positive electrode lead 5a was welded to a sealing plate 2 having a safety valve operated by internal pressure, thereby placing these members in the battery case 1. After that, the nonaqueous electrolyte was poured in the battery case 1 at a reduced pressure. Finally, the sealing plate 2 was crimped to an opening end of the battery case 1 with a gasket 3 interposed therebetween, thereby completing Battery A. The battery capacity of the obtained cylindrical battery was 2000 mAh.

### SECOND EXAMPLE

A negative electrode active material R2 is calcium manganese composite oxide Sr_{1.9}Fe₂O₅ synthesized in the same manner as in the first example except that starting materials were mixed together so that the molar ratio of Sr:Fe is 1.9:2. Battery B was fabricated in the same manner as for Battery A except that the negative electrode active material R2 was used.

In a crystal structure of Sr_{1.9}Fe₂O₅, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +3.1.

### THIRD EXAMPLE

A negative electrode active material R3 is strontium iron composite oxide Sr_{2.1}Fe₂O₅ synthesized in the same manner as in the first example except that starting materials were mixed together so that the molar ratio of Sr:Fe is 2.1:2. Battery C was fabricated in the same manner for Battery A except that the negative electrode active material R3 was used.

In a crystal structure of Sr_{2.1}Fe₂O₅, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +2.9.

### FOURTH EXAMPLE

A negative electrode active material R4 is strontium iron composite oxide Sr₂Fe_{1.9}O₅ synthesized in the same manner as in the first example except that starting materials were mixed together so that the molar ratio of Sr:Fe is 2:1.9. Battery D was fabricated in the same manner as for Battery A except that the negative electrode active material R4 was used.

In a crystal structure of Sr₂Fe_{1.9}O₅, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +3.16.

### FIFTH EXAMPLE

A negative electrode active material R5 is strontium iron composite oxide Sr₂Fe_{2.1}O₅ synthesized in the same manner as in first example except that starting materials were mixed together so that the molar ratio of Sr:Fe is 2:2.1. Battery E was fabricated in the same manner as for Battery A except that the negative electrode active material R5 was used.

In a crystal structure of Sr₂Fe_{2.1}O₅, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +2.86.

### SIXTH EXAMPLE

A negative electrode active material R6 is strontium iron composite oxide Sr₂Fe₂O_{4.7} synthesized in the same manner as in the first example except that a mixture of Fe₃O₄ and SrCO₃ was burned in an atmosphere in which nitrogen/hydrogen=90/10. Battery F was fabricated in the same manner as for Battery A except that the negative electrode active material R6 was used.

In a crystal structure of Sr₂Fe₂O_{4.7}, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +2.7.

### SEVENTH EXAMPLE

A negative electrode active material R7 is strontium iron composite oxide Sr₂Fe₂O_{5.3} synthesized in the same manner as in the first example except that a mixture of Fe₃O₄ and SrCO₃ was burned in an atmosphere in which nitrogen/oxygen=90/10. Battery G was fabricated in the same manner as for Battery A except that the negative electrode active material R7 was used.

In a crystal structure of Sr₂Fe₂O_{5.3}, the energy level of the 5s orbit of Sr is higher than that of the 3d orbit of Fe, and the energy level of the 4p orbit of Sr is lower than that of the 3d orbit of Fe. Thus, the formal oxidation number of Sr is +2, and the formal oxidation number of Fe is +3.3.

### EIGHTH EXAMPLE

A negative electrode active material R8 is barium iron composite oxide Ba₂Fe₂O₅ synthesized in the same manner as in the first example except that 443 g of SrCO₃ was substituted with 593 g of BaCO₃. Battery H was fabricated in the same manner as for Battery A except that the negative electrode active material R8 was used.

In a crystal structure of Ba₂Fe₂O₅, the energy level of the 6s orbit of Ba is higher than that of the 3d orbit of Fe, and the energy level of the 5p orbit of Ba is lower than that of the 3d orbit of Fe. Thus, the formal oxidation number of Ba is +2, and the formal oxidation number of Fe is +3.

### NINTH EXAMPLE

A negative electrode active material R9 is magnesium iron composite oxide Mg₂Fe₂O₅ synthesized in the same manner as in the first example except that 443 g of SrCO₃ was substituted with 253 g of MgCO₃. Battery I was fabricated in the same manner as for Battery A except that the negative electrode active material R9 was used.

In a crystal structure of Mg₂Fe₂O₅, the energy level of the 3s orbit of Mg is higher than that of the 3d orbit of Fe, and the energy level of the 2p orbit of Mg is lower than that of the 3d orbit of Fe. Thus, the formal oxidation number of Mg is +2, and the formal oxidation number of Fe is +3.

### FIRST COMPARATIVE EXAMPLE

Comparative Battery 1 was fabricated in the same manner as for Battery A except that Li₂CO₃ and TiO₂ were mixed together to obtain a preferable composition, the obtained mixture was burned in an atmosphere at 900° C. for 12 hours, and the obtained Li₄Ti₅O₁₂ was used as a negative electrode active material.

### SECOND COMPARATIVE EXAMPLE

Comparative Battery 2 was fabricated in the same manner as for Battery A except that 60 g of Fe₃O₄ and 77 g of SrCO₃ were mixed together well using a mortar made of agate, and reaction of the obtained mixture was caused in an air atmosphere at 800° C. for 24 hours and 1150° C. for 36 hours to synthesize SrFeO₃, which was used as a negative electrode active material.

### THIRD COMPARATIVE EXAMPLE

Comparative Battery 3 was fabricated in the same manner as for Battery A except that artificial graphite was used as a negative electrode active material.

Batteries A-I in the examples and Comparative Batteries 1-3 were evaluated in the following method. The results are shown in Table 1.

TABLE 1

| | | | Negative Electrode | | |
|---|---|---|---|---|---|
| | | | Active Material | | C Rate at which |
| | | | Electrochemical | Negative Monopole | Negative Monopole |
| | | Negative Electrode | Capacity | Average Voltage | Voltage Reaches 0 V |
| Battery No. | | Active Material | (mAh/g) | (V/Li/Li⁺) | At 0° C.□(C) |
| Ex. | A | Sr₂Fe₂O₅ | 205 | 0.6 | 12 |
| Ex. | B | Sr_{1.9}Fe₂O₅ | 200 | 0.7 | 11 |
| Ex. | C | Sr_{2.1}Fe₂O₅ | 200 | 0.7 | 12 |
| Ex. | D | Sr₂Fe_{1.9}O₅ | 210 | 0.7 | 12 |
| Ex. | E | Sr₂Fe_{2.1}O₅ | 205 | 0.6 | 15 |
| Ex. | F | Sr₂Fe₂O_{4.7} | 200 | 0.7 | 11 |
| Ex. | G | Sr₂Fe₂O_{5.3} | 200 | 0.6 | 11 |
| Ex. | H | Ba₂Fe₂O₅ | 200 | 0.7 | 12 |
| Ex. | I | Mg₂Fe₂O₅ | 205 | 0.7 | 12 |
| Compar. | 1 | Li₄Ti₅O₁₂ | 150 | 1.5 | 20 |
| Ex. | | | | | |
| Compar. | 2 | CaFeO₃ | 90 | 1.0 | 10 |
| Ex. | | | | | |
| Compar. | 3 | Artificial | 300 | 0.05 | 6 |
| Ex. | | Graphite | | | |

-Discharge Characteristics-

Each Battery was subjected to two times of preliminary charge/discharge, and then was stored at 40° C. for 2 days. The preliminary charge/discharge was performed under the following conditions.

Charge: Batteries were charged at a constant current of 400 mA to a battery voltage of 4.1 V at 25° C. After that, Batteries were charged at a constant voltage of 4.1 V until the charging current decreased to 50 mA.

Discharge: Batteries were discharged at a constant current of 400 mA to a battery voltage of 2.5 V at 25° C. The preliminary charge/discharge was performed under the following conditions.

Charge: Batteries were charged at a constant current of 400 mA to a battery voltage of 4.1 V at 25° C. After that, Batteries were charged at a constant voltage of 4.1 V until the charging current decreased to 50 mA.

Discharge: Batteries were discharged at a constant current of 400 mA to a battery voltage of 2.5 V at 25° C.

After that, each Battery was charged/discharged under the following conditions.

<Charge/Discharge Conditions>

(1) Constant Current Charge (25° C.): 1400 mA (end voltage 4.2 V)

(2) Constant Voltage Charge (25° C.): 4.2 V (end current 0.05 CmA)

(3) Constant Current Discharge (25° C.): 400 mA (end voltage 3 V)

The discharge capacity of negative electrode per weight of its active material after two cycles of charge/discharge under the above conditions is shown in Table 1. As illustrated in Table 1, it can be seen that the negative electrode active materials R1-R9 of the present embodiment have a higher capacity in comparison to Li₄Ti₅O₁₂ and CaFeO₃ of the comparative examples.

Moreover, after discharge in the second cycle under the above conditions, each cylindrical battery after removing its sealing plate was immersed in an electrolyte in a polypropylene (PP) container together with a lithium metal wire (reference electrode), and only one cycle of charge/discharge was performed under the above conditions. The average voltage of the negative monopole with respect to the lithium reference electrode during charge in the one cycle is also shown in Table 1.

As shown in Table 1, it can be seen that Batteries A-I using the negative electrode active materials R1-R9 of the present embodiment have operating voltages of 0.5-0.7 V relative to the lithium reference electrode, and thus it is possible to obtain batteries having a higher energy density in comparison to batteries using Li₄Ti₅O₁₂ and CaFeO₃ of the comparative examples as negative electrode active materials.

Moreover, after measuring the monopole voltage, measurement was performed in a manner such that the state of charge (SOC) was adjusted to 50%, and the charging current value (C rate) was stepwise increased at 0° C. until the monopole voltage reached 0 V.

Here, C of the C rate is an hour rate defined as: (1/X)C=Rated Capacity(Ah)/X(h). X represents the time period during which electricity for the rated capacity is charged or discharged. For example, 0.5 CA means that the current value is the rated capacity (Ah)/2(h).

The C rate at which the negative monopole voltage reached 0 V is also shown in Table 1.

As shown in Table 1, up to 15 C, the negative monopole voltages of Batteries A-I of the examples of the present embodiment did not reach 0 V at 0° C. In contrast, Comparative Battery 3 reached 0 V at 6 C. Thus, it can be said that Batteries A-I of the examples are highly reliable batteries in which lithium metal is less likely to be deposited in comparison to Comparative Battery 3.

### OTHER EMBODIMENTS

The above embodiments and examples are mere examples of the present invention, and do not limit the present invention. For example, as the negative electrode active material, two or more elements corresponding to A may be used in combination. Moreover, as to elements corresponding to B, elements other than Fe, e.g., Ti, V, Zr, Al, etc. may be used together with Fe. Capability of the negative electrode active material such as operating potential can be estimated based on the crystal structure and the oxidation state. Furthermore, the negative electrode active material is not limited to one kind, but a mixture of two or more negative electrode active materials may be used in one battery. In this case, as a part of the negative electrode active material, negative electrode active materials other than the material represented by formula (1) may be added.

Note that although cylindrical batteries have been used in the above examples, similar advantages can be obtained in batteries in other shapes, e.g., in a rectangular shape.

### INDUSTRIAL APPLICABILITY

When a negative electrode active material obtained by the present invention for a lithium ion secondary battery is used, it is possible to provide a lithium ion secondary battery which is low-cost, and has a high energy density and high reliability, and the present invention is useful as power supplies in an environmental energy field such as electric power storages and electric vehicles.

### DESCRIPTION OF REFERENCE CHARACTERS

1 Battery Case
2 Sealing Plate
3 Gasket
5 Positive Electrode
5a Positive Electrode Lead
6 Negative Electrode
6a Negative Electrode Lead
7 Separator
8a Upper Insulating Plate
8b Lower Insulating Plate
9 Electrode Plate Group

1. A negative electrode active material for a lithium ion secondary battery, the negative electrode active material made of a metal composite oxide represented by a formula
A_{2±x}B_{2±y}O_{5±z} (1)
(0≦x≦0.1, 0≦y≦0.1, 0≦z≦0.3, A includes one selected from the group consisting of strontium, barium, and magnesium, but does not include manganese and calcium, and B includes at least iron, but does not include manganese), wherein
a formal oxidation number of A is +2, and
a formal oxidation number of B is greater than or equal to +2.5 and less than or equal to +3.3.

2. A lithium ion secondary battery comprising:
a negative electrode plate;
a positive electrode plate;
a separator provided between the negative electrode plate and the positive electrode plate;
a nonaqueous electrolyte; and
a battery case, wherein
the nonaqueous electrolyte and an electrode plate group including the negative electrode plate, the positive electrode plate, and the separator are sealed in the battery case, and
the negative electrode plate includes the negative electrode active material of claim 1.
